(19) United States
(12) Patent Application Publication
(10) Pub. No.: US 2007/0175307 A1
(43) Pub. Date: Aug. 2, 2007

(54) Cutting device and printer

(76) Inventor: Akihiko Ito, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/650,789

(22) Filed: Jan. 8, 2007

(30) Foreign Application Priority Data
Jan. 30, 2006 (JP) 2006-020296

(51) Int. Cl. B26D 1/08

(52) U.S. Cl. 83/583; 83/636

(57) ABSTRACT

A cutting device includes a movable blade and a stationary blade opposed to the movable blade across a sheet-like object to be cut. The movable blade is formed into a concave shape retracted inwardly from opposite end portions toward a central portion thereof. The stationary blade is formed into a straight line in parallel to the cut surface of the object. An angle of each of portions of the cutting edge on sides of the opposite end portions with respect to a cut surface of the object to be cut is larger than an angle of each of portions of the cutting edge on both sides of the central portion with respect to the cut surface.

This application claims priority to Japanese Patent Application No. 2006-020296 filed Jan. 30, 2006, the entire content of which is hereby incorporated by reference.

### BACKGROUND OF THE INVENTION

The present invention relates to a cutting device for cutting a sheet-like object to be cut, and to a printer having the cutting device.

Conventionally, there has been proposed, for example, a printer including therein a recording device and a cutting device for effecting recording on a part of a long continuous paper and for producing a cut sheet having a predetermined length by cutting the part on which recording is effected. A typical cutting device includes a stationary blade and a movable blade and has a structure in which the movable blade is moved so that the movable blade and the stationary blade sandwich the continuous paper to cut the continuous paper. In such the cutting device, in a case where both a cutting edge of the movable blade and a cutting edge of the stationary blade constitute straight lines in parallel to a cut surface of a paper which is the object to be cut, the paper is cut over an entire width at one time. Therefore, working efficiency of the cutting device is high, but resistance at a time of cutting is high, so there are some cases where the paper cannot be smoothly cut.

Thus, as shown in FIG. 10, there is used a cutting device 32 in which a cutting edge 31 of a movable blade 30 is retracted inwardly (recessed) from opposite end portions to a central portion thereof to constitute a concave shape, for example, a V-shaped configuration rather than a straight line. In the cutting device 32, when the movable blade 30 is advanced toward a stationary blade 33, portions of the cutting edge 31 on sides of the opposite end portions of the movable blade 30 first cut into the paper on a skew and then cut further into the paper gradually inward from portions on outer sides in a width direction of the paper. Accordingly, the resistance at the time of cutting is low, so it is possible to smoothly cut the paper (refer to JP H11-123692 A (FIGS. 3 and 4)).

As described above, the use of the cutting device 32 including the movable blade 30 having the concave cutting edge 31 enables smooth cutting of the paper. However, there are cases where, as the object to be cut, a sheet material (having a thickness of, for example, about 150 μm or more) which is thicker than a conventional recording paper (having a thickness of, for example, about 65 μm or more to less than about 150 μm) or a sheet material which is harder than the conventional recording paper is used. In this case, there may arise a problem in that the sheet material is not cut but bent. Thus, reduction in resistance at the time of cutting is being demanded.

It is therefore an object of the present invention to provide a cutting device with which it is possible to easily and smoothly cut the object to be cut which is thicker and harder than the conventional recording paper by reducing the resistance particularly at a start of cutting, and which can be prevented from being increased in size, and a printer including the cutting device.

### SUMMARY OF THE INVENTION

A cutting device according to the present invention is characterized by including: a movable blade which has a cutting edge formed into a concave shape retracted inwardly from opposite end portions toward a central portion thereof, and in which an angle of each of portions of the cutting edge on sides of the opposite end portions with respect to a cut surface of a sheet-like object to be cut is larger than an angle of each of portions of the cutting edge on both sides of the central portion with respect to the cut surface; and a stationary blade opposed to the movable blade across the object to be cut.

With this construction, at the start of cutting which is considered to be a time when the blades meet with the highest resistance, the portions of the cutting edge each forming a larger angle with respect to the cut surface cut into the object to be cut at an acute angle, thereby making it possible to smoothly start cutting. Further, after the smooth cutting is performed to a certain extent, the central portion of the object to be recorded is cut by the portions of the cutting edge each forming a smaller angle with respect to the cut surface, thereby preventing significant elongation of cutting time and significant increase in size of the movable blade and the stroke thereof. Thus, it is possible to suppress increase in size of the cutting device as a whole.

Note that the cutting device is particularly effective in a case of using a flat sheet material such as a continuous paper or a cut sheet as the object to be cut. Accordingly, a phrase “object to be cut” used herein refers to a flat sheet material in most cases.

A cutting edge of the stationary blade may constitute a straight line in parallel to the cut surface.

A printer according to the present invention is characterized by including a recording device for effecting recording on the recording medium and a cutting device having one of the above-mentioned structures in which the recording medium on which recording is effected by the recording device is cut as an object to be cut. According to the printer, it is possible to cut the continuous paper to a predetermined length to continuously produce the cut sheets with ease each of which has undergone desired recording.

According to the present invention, at a start of cutting when resistance to cutting is at the maximum level, a cutting edge having portions each forming a larger angle with respect to a cut surface is used, thereby making it possible to reduce the resistance as compared to the prior art. Accordingly, even a thick and hard object to be cut can be cut relatively smoothly. Further, in a latter half of a cutting process, in which the resistance to cutting is lower than that at the start of cutting, the cutting edge having portions each forming a smaller angle with respect to the cut surface is used, thereby making it possible to complete the cutting in a relatively short time. Further, it is not necessary to increase the movable blade and the stroke thereof in size, thereby making it possible to suppress increase in size of the cutting device as a whole.

### BRIEF DESCRIPTION OF THE DRAWINGS

FIG. 1A is a perspective view of a cutting device according to a first embodiment of the present invention.

FIG. 1B is a perspective-view of a cutting device according to a first embodiment of the present invention, in a state where an upper cover thereof is removed.

FIG. 1C a side sectional view of a cutting device according to a first embodiment of the present invention.

FIG. 2 is a perspective view for illustrating a cutting operation of the cutting device shown in FIG. 1 with the upper cover thereof being removed.

FIG. 3 is an enlarged plan view of a movable blade and a stationary blade of the cutting device shown in FIG. 1.

FIG. 4 is an enlarged plan view of a movable blade and a stationary blade of a cutting device according to a comparative example.

FIG. 5 is a perspective view of a printer according to the first embodiment of the present invention.

FIG. 6A is a perspective view of a recording device of the printer shown in FIG. 5.

FIG. 6B is a side sectional view of a recording device of the printer shown in FIG. 5.

FIG. 7 is an enlarged plan view of a movable blade and a stationary blade of a cutting device according to a second embodiment of the present invention.

FIG. 8 is an enlarged plan view of a movable blade and a stationary blade of the cutting device according to a third embodiment of the present invention.

FIG. 9 is an enlarged plan view of a movable blade and a stationary blade of a cutting device according to a fourth embodiment of the present invention.

FIG. 10 is an enlarged plan view of a movable blade and a stationary blade of a conventional cutting device.

### DETAILED DESCRIPTION OF THE INVENTION

In the following, embodiments of the present invention will be described with reference to the drawings.

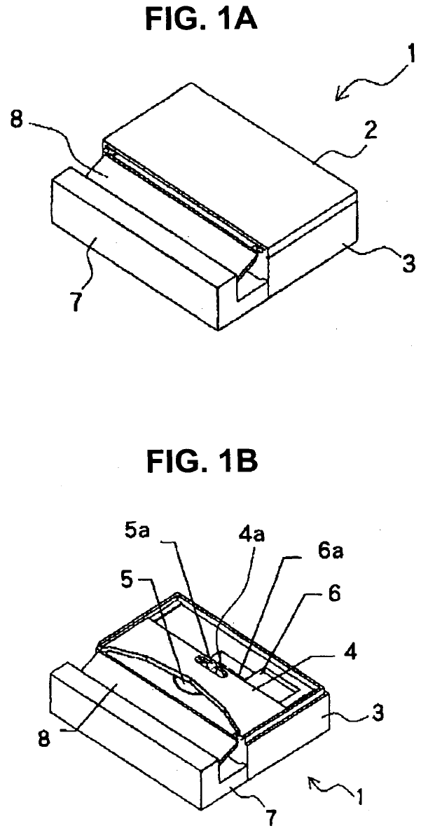

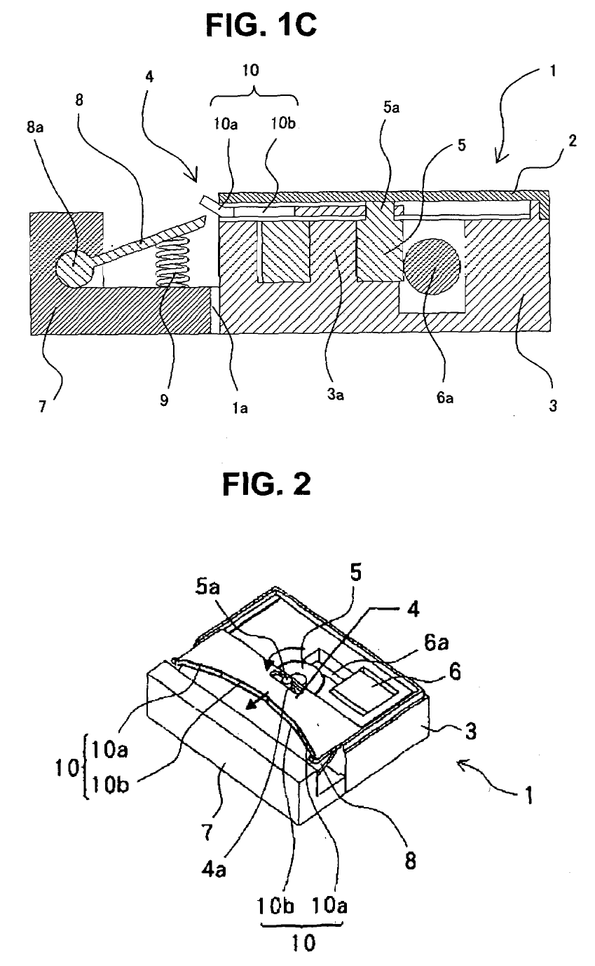

FIGS. 1 and 2 each show a cutting device 1 of the present invention. FIG. 1A is a perspective view of the cutting device 1, FIG. 1B is a perspective view of a state where an upper cover 2 of the cutting device 1 is removed, and FIG. 1C is a side sectional view of the cutting device 1. FIG. 2 is a perspective view showing a cutting operation of the cutting device 1 with the upper cover 2 thereof being removed.

In the cutting device 1, a casing 3 includes therein a movable blade 4, a drive gear 5, and a motor 6 which are covered with the upper cover 2. Further, a stationary blade 8 and a stationary blade pressing spring 9 are mounted on a frame 7 attached to the casing 3. A shaft 3a provided in the casing 3 is engaged with a central hole of the drive gear 5 such that the drive gear 5 is attached so as to be rotatable. The motor 6 arranged in the casing 3 has a drive shaft to which a worm gear 6a is attached. The worm gear 6a meshes with the drive gear 5. On an upper surface of the drive gear 5, there is provided a drive cam 5a. The drive cam 5a is inserted into a long hole 4a provided in the movable blade 4.

Attached to the frame 7 is the stationary blade pressing spring 9, and the stationary blade 8 is held on the frame 7 so as to be rockable about a shaft 8a. The stationary blade pressing spring 9 biases the stationary blade 8 while abutting therewith to hold the stationary blade 8 in a predetermined position.

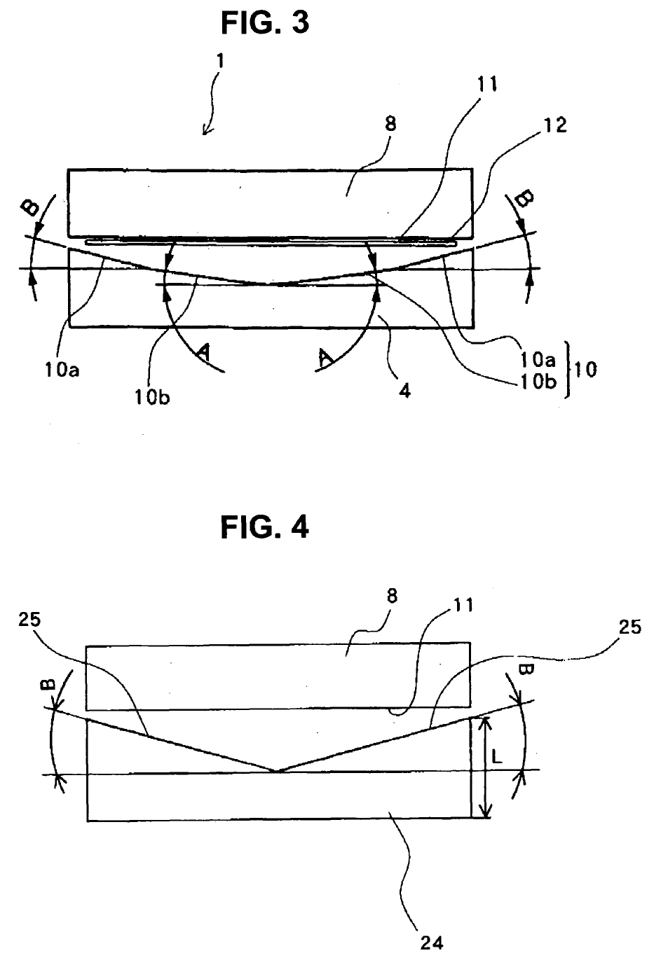

Thus, when the motor 6 operates, a driving force is transmitted through the worm gear 6a to the drive gear 5. The drive gear 5 is thereby rotated about the shaft 3a. When the drive gear 5 rotates, the movable blade 4 moves horizontally, while the drive cam 5a moves in the long hole 4a. As the drive gear 5 rotates, the movable blade 4 reciprocates, that is, moves toward and away from the stationary blade 8. The stationary blade 8 is held in the predetermined position by the stationary blade pressing spring 9. When the movable blade 4 advances as shown in FIG. 2, a cutting edge 10 of the movable blade 4 approaches to oppose a cutting edge 11 of the stationary blade 8, or in some cases, those edges slide on each other while being brought into contact with each other. At this time, when the object to be cut (a sheet material 12 of FIG. 3, or the like) exists between the movable blade 4 and the stationary blade 8, the object to be cut is sandwiched by both the cutting edges 10 and 11 to be cut by those.

In the cutting device 1 having a basic structure as described above, according to the present invention, the cutting edge 10 of the movable blade 4 is formed into a concave shape as shown in FIG. 3, in particular, a V-shaped configuration. That is, the cutting edge 10 is inclined inwardly from the opposite end portions towards the central portion. Further, according to this embodiment, the cutting edge 10 is composed of first portions 10a respectively positioned on opposite end portion sides and second portions 10b respectively positioned on both sides of the central portion. An angle B (for example, about 10 to 12 degrees) formed by each of the first portions 10a with respect to the cut surface of the object to be cut (for example, the flat sheet material 12) is larger than an angle A (for example about 5 to 7 degrees) formed by each of the second portions 10b with respect to the cut surface. On the other hand, the cutting edge 11 of the stationary blade 8 is formed into a straight line in parallel to the cut surface. In a case where a width of the sheet material 12 which is the object to be cut is about 110 to 115 mm and a width of the cutting edge 10 of the movable blade 4 is almost the same as the width of the sheet material 12, the first portions 10a are formed in regions each inwardly extending up to about 10 mm from each of the opposite end portions of the cutting edge 10.

With this construction, in a case where the sheet material 12 is cut by the cutting device 1 of this embodiment, the motor 6 is operated in a state where the sheet material 12 is inserted between the movable blade 4 and the stationary blade 8 to allow the movable blade 4 to advance toward the stationary blade 8 through an intermediation of the drive gear 5. First, the first portions 110a of the cutting edge 10 of the advancing movable blade 4 cut into the opposite end portions in the width direction of the sheet material 12. At this time, since the angle B formed by each of the first portions 10a with respect to the cut surface of the sheet material 12 is larger, the first portions 10a cut into the sheet material 12 at an acute angle. Thus, the resistance to cutting is low and the cutting is started smoothly. In this manner, the first portions 10a cut the sheet material 12 gradually from portions positioned on outer sides in the width direction of the sheet material 12. After completion of the cutting by the first portions 10a, the second portions 10b cut the central portion and portions near the central portion of the sheet material 12. Since the angle A which is formed by each of the second portions 10b with respect to the cut surface of the sheet material 12 is smaller, the resistance at the time of cutting is larger than that in the case of using the first portions 10a. However, the smooth cutting operation of the sheet material 12 by the first portions 10a has already been performed, and the cutting operation is subsequently performed, that is, the sheet material 12 already having slits is further cut, thereby making it possible to continue relatively smooth cutting. Note that, in the above-mentioned cutting processes, the stationary blade 8 serves to prevent warping of the sheet material 12 and to sandwich the sheet material 12 between the movable blade 4 and itself to cut the sheet material 12.

According to this embodiment, at the start of cutting which is the time when the cut resistance is at the maximum level, that is, at the start of cutting the sheet material 12 having no slit, the first portions 10a each forming the larger angle B with respect to the cut surface of the sheet material 12 are used. Therefore, cutting into the sheet material 12 is effected at the acute angle, thereby making it possible to start cutting easily and smoothly. After the cutting operation is smoothly started, the second portions 10b each forming the smaller angle A with respect to the cut surface of the sheet material 12 are used to cut the sheet material 12 through to completion.

If, as shown in FIG. 4, an entire portion of a cutting edge 25 of a movable blade 24 is formed to have the larger angle B with respect to the cut surface of the sheet material 12, a length L of the movable blade 24 becomes longer. Therefore, the resistance at the time of cutting from the start to the end of cutting is low, but more time is required for cutting. Further, the length L of the movable blade 24 is longer and a movement stroke of the movable blade 24 is larger, thereby inducing increase in the size of the cutting device as a whole.

On the other hand, according to the structure of this embodiment, the cutting is made easier and smoother as described above. Further, since the angle A formed by each of the second portions 10b with respect to the cut surface of the sheet material 12 is small, so the length of the movable blade 4 is not significantly increased, thereby making it possible to suppress increase in the size of the cutting device 1 as a whole and to prevent substantial elongation of cutting time.

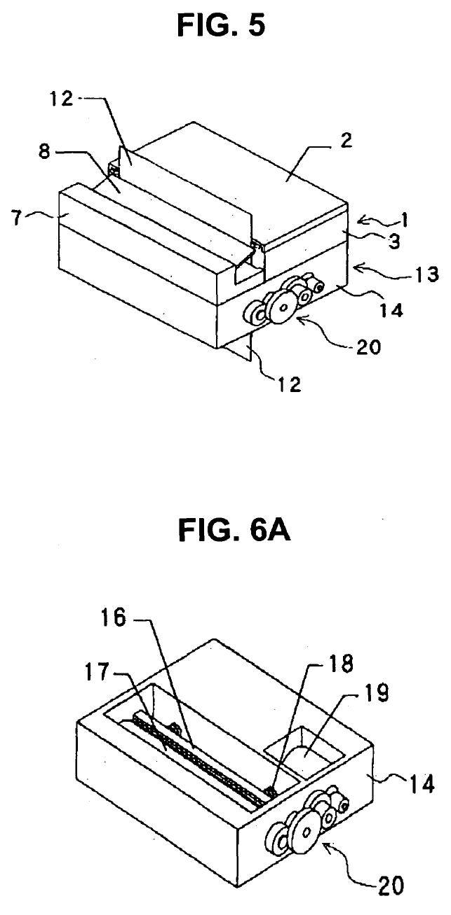

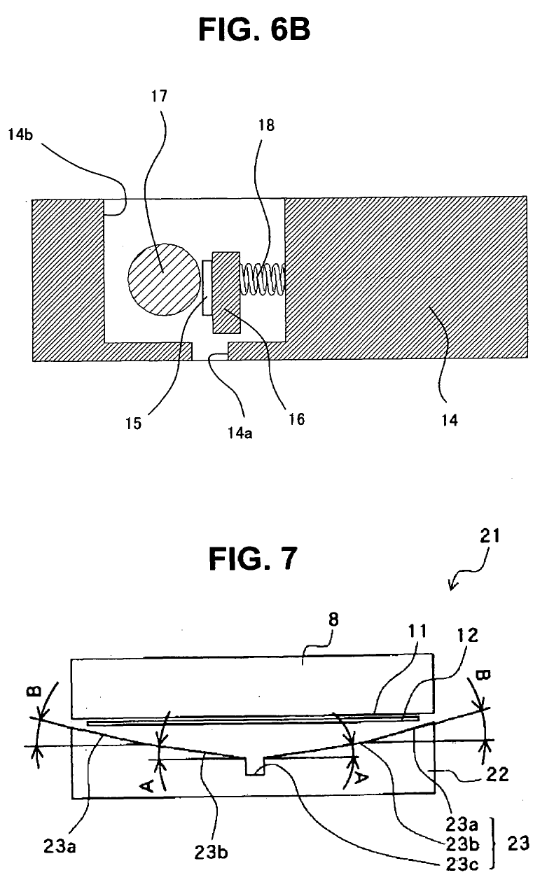

In FIG. 5, a printer including the cutting device 1 of this embodiment is shown. The printer has a structure in which the cutting device 1 is stacked on a recording device 13. In the recording device 13, as shown in FIGS. 6A and 6B, a frame 14 includes therein a thermal head 15 for effecting recording on a recording medium, a supporting body 16 for the thermal head 15, a platen roller 17 which rotates to convey the recording medium, a head pressing spring 18, and a motor 19. The thermal head 15 is biased by the head pressing spring 18 integrally with the supporting body 16 and abuts on the platen roller 17. On a lateral side of the frame 14, there is arranged a gear group (wheel train) 20 for transmitting a rotary force of the motor 19 to the platen roller 17. The frame 14 is open to an outside at least in portions above and below a position where the thermal head 15 and the platen roller 17 come into contact with or are adjacent to each other. Those portions constitute an insertion portion 14a and a discharge portion 14b for the recording medium. On the recording device 13, the cutting device 1 having the above-mentioned structure is disposed.

According to the printer having the above-mentioned structure, the recording medium such as the sheet material 12 is inserted into the recording device 13 from a lowest portion of the frame 14 through the insertion portion 14a into the recording device 13. When the motor 19 is operated to allow the platen roller 17 to rotate through the intermediation of the gear group 20, the sheet material 12 inserted into the recording device 13 moves upwardly inside the frame 14. At this time, the thermal head 15, which abuts on the platen roller 17 while being pressed integrally with the supporting body 16 by the head pressing spring 18, is driven by a drive mechanism (not shown) to effect recording on the sheet material 12 positioned between the thermal head 15 and the platen roller 17. The sheet material 12 on which recording is thus effected enters from the discharge portion 14b a gap 1a between the casing 3 and the frame 7 of the cutting device 1 (refer to FIG. 1C). On the sheet material 12 entering the gap 1a, predetermined recording is completely effected, and a portion on which recording is effected is entirely discharged from the discharge portion 14b of the recording device 13 to enter the cutting device 1.

When a predetermined cutting position of the sheet material 12 reaches between the movable blade 4 and the stationary blade 8 of the cutting device 1, the platen roller 17 stops and the sheet material 12 thus temporarily stops. The motor 6 of the cutting device 1 then operates to allow the movable blade 4 to advance toward the stationary blade 8 through the intermediation of the drive gear 5, and the movable blade 4 and the stationary blade 8 sandwich the sheet material 12 to cut the sheet material 12. At this time, as described above, the first portions 10a of the cutting edge 10 of the movable blade 4 cut into the opposite end portions in the width direction of the sheet material 12- to smoothly start the cutting. After the cutting by the first portions 10a, the second portions 10b cut the central portion and portions near the central portion of the sheet material 12. The sheet material 12 on which recording is effected and which is cut to an appropriate length is taken out from a portion between the casing 3 and the frame 7 to above the cutting device 1.

According to the printer, from the continuous sheet material 12, it is possible to continuously produce a plurality of cut sheet materials 12 on each of which recording is effected and each of which is cut to a predetermined length and independent as a single sheet. In particular, by using a control device (not shown), the cutting device 1 and the recording device 13 are interlocked with each other to allow the motor 6 to be automatically driven in synchronism with operations of the thermal head 15 and the platen roller 17. As a result, it is possible to automate the cutting.

In FIG. 7, a main portion of a cutting device 21 according to a second embodiment of the present invention is shown. The cutting device 21 is different from that of the first embodiment in a shape of a cutting edge 23 of a movable blade 22, but other constructions are identical with those of the cutting device 1 according to the first embodiment. Therefore the same constructions are denoted by the same reference symbols, and descriptions of those will be omitted.

The cutting edge 23 of the movable blade 22 of the cutting device 21 according to this embodiment includes first portions 23a on sides of opposite end portions thereof, second portions 23b on both sides of a central portion thereof, and further, a notch portion 23c provided in the central portion. In other words, the cutting edge 23 constitutes a Y-shaped configuration. An angle B, formed by each of the first portions 23a of the cutting edge 23 of the movable blade 22 with respect to the cut surface of the object to be cut (sheet material 12) is larger than an angle A formed by each of the second portions 23b with respect to the cut surface of the sheet material 12. Therefore, also in this embodiment, the same effect as that of the first embodiment can be obtained. However, in this embodiment, the central portion 23c of the movable blade 22 does not come into contact with the sheet material 12 even when the movable blade 22 is advanced, thereby not cutting the sheet material 12. According to the cutting device 12, a major part of the sheet material 12 is cut, while only a central portion thereof is left uncut. That is, it is possible to produce a sheet material having a configuration in which a plurality of independent sheets are connected to each other in a manner that the sheet material can be manually torn off by a user with ease.

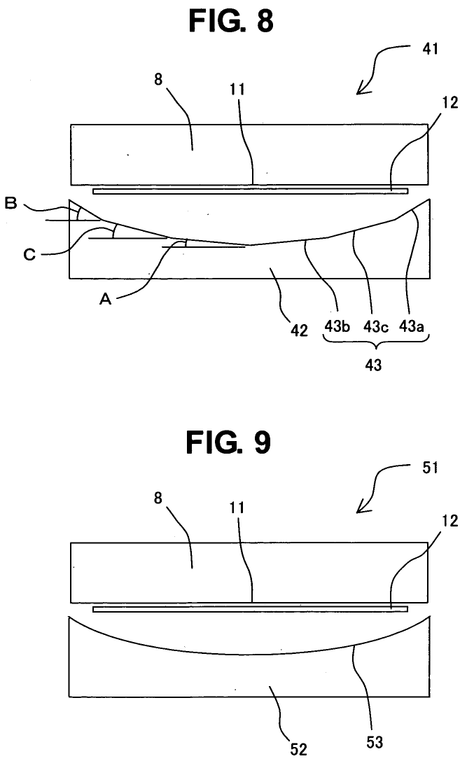

Further, as shown in FIG. 8, the cutting edge 43 of the movable blade 42 of the cutting device 41 according to a third embodiment of the present invention may have, similarly to the first embodiment, first portions 43a on the sides of the opposite end portions and second portions 4.3b on both sides of the central portion, and may further have third portions 43c each positioned between the first portion 43a and the second portion 43b. An angle B formed by each of the first portions 43a of the cutting edge 43 of the movable blade 42 with respect to the cut surface of the object to be cut (sheet material 12) is larger than an angle C formed by each of the third portions 43c with respect to the cut surface. The angle C formed by each of the third portions 43c with respect to the cut surface is larger than the angle A formed by each of the second portions 43b with respect to the cut surface. That is, the cutting edge 43 of the movable blade 42 has a configuration in which there are formed, from the opposite end portion sides toward the central portion, the first portions 43a each forming a larger angle B with respect to the cut surface of the sheet material 12, the third portions 43c each forming a medium angle C with respect to the cut surface, and the second portions 43b each forming a smaller angle A with respect to the cut surface in the stated order.

With this construction, the angle of the cutting edge 43 is changed to three levels, so the same effect as that of the first embodiment can be obtained. Further, transition is made from cutting by the first portions 43a to cutting by the second portions 43b through an intermediation of cutting of the third portions 43c, so resistance at the time of cutting changes more moderately. Accordingly, a risk of the operation being interrupted in the middle of the cutting process is reduced. Note that, the angle of the cutting edge may be changed to four or more levels.

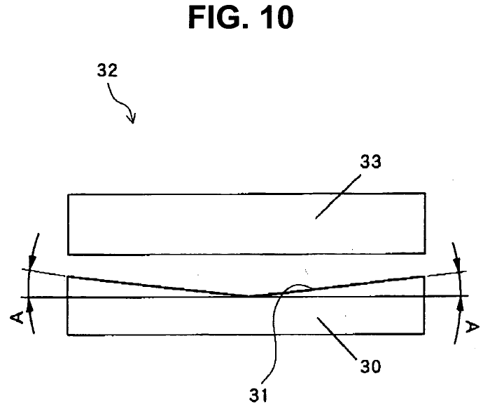

Further, as shown in FIG. 9, the angle of the cutting edge 53 of the movable blade 52 of the cutting device 51 according to a fourth embodiment of the present invention may be changed in a stepless manner. That is, the cutting edge 53 of the movable blade 52 is recessed inwardly from the opposite end portions to the central portion thereof to constitute the concave shape like in the first embodiment, but may constitute a substantially U-shaped configuration formed of a continuous curve.

In such the cutting edge 53 of the movable blade 52, unlike the first portions 10a and the second portions 10b of the first embodiment, the portions positioned on the opposite end portion sides and the portions positioned on the central portion side are not clearly separated. However, the angle formed by each of the portions on the opposite end portion sides with respect to the cut surface of the object to be cut (sheet material 12) is larger than the angle formed by each of the portions on the central portion side with respect to the cut surface. With this construction also, the same effect as that of the first embodiment is obtained, and the resistance at the time of cutting does not change rapidly but changes moderately. Therefore, the risk of the operation being interrupted in the middle of the cutting process is reduced.

In the above-mentioned description, in all cutting devices, the cutting edge 11 of the stationary blade 8 constitutes a straight line in parallel to the cut surface of the object to be cut. However, this should be not construed restrictively, the cutting edge 11 may have a convex shape, a concave shape, or a curved shape.

1. A cutting device, comprising:
a movable blade which has a cutting edge formed into a concave shape retracted inwardly from opposite end portions toward a central portion thereof, and in which an angle of each of portions of the cutting edge on sides of the opposite end portions with respect to a cut surface of a sheet-like object to be cut is larger than an angle of each of portions of the cutting edge on both sides of the central portion with respect to the cut surface; and
a stationary blade opposed to the movable blade across the object to be cut.

2. The cutting device according to claim 1,
wherein the cutting edge of the movable blade comprises first portions respectively positioned on opposite end portion sides and second portions respectively positioned on both sides of the central portion.

3. The cutting device according to claim 1,
wherein the cutting edge of the movable blade comprises three or more pair of portions, and the angle of the cutting edge is changed to three or more levels.

4. The cutting device according to claim 1,
wherein the cutting edge of the movable blade constitutes a continuous curve, and the angle of the cutting edge is changed in a stepless manner.

5. The cutting device according to claim 1,
wherein a cutting edge of the stationary blade constitutes a straight line in parallel to the cut surface.

6. A printer, comprising:
a recording device for effecting recording on a recording medium; and
the cutting device according to claim 1, for cutting the recording medium, on which recording is effected by the recording device, as an object to be cut.
